(19) United States
(12) Patent Application Publication
(10) Pub. No.: US 2025/0240825 A1
(43) Pub. Date: Jul. 24, 2025

(54) UE-SPECIFIC RANDOM ACCESS PREAMBLE RECEPTION ERROR INDICATION AND ASSISTANCE INFORMATION FOR WIRELESS NETWORKS

(71) Applicant: Nokia Technologies Oy, Espoo (FI)

(72) Inventors: Konstantinos MANOLAKIS, Munich (DE); Frank FREDERIKSEN, Klarup (DK); Rafhael MEDEIROS DE AMORIM, Aalborg (DK)

(21) Appl. No.: 18/848,848

(22) PCT Filed: Mar. 23, 2022
(86) PCT No.: PCT/EP2022/057601

§ 371 Date: Sep. 19, 2024

(51) Int. Cl. H04W 74/0833; H04L 5/00; H04W 74/00

(52) U.S. Cl. CPC H04W 74/0833; H04L 5/0005; H04W 74/002

(57) ABSTRACT

According to example embodiments, a method may include transmitting, by a user device to a network node, a first random access preamble; receiving, by the user device from the network node, a random access procedure message that includes a random access preamble reception error indication; and performing, by the user device based on the received random access procedure message, at least one of a time adjustment or a frequency adjustment to improve time and/or frequency synchronization between the user device and the network node for transmission of a second random access preamble.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include transmitting, by a user device to a network node, a first random access preamble; receiving, by the user device from the network node, a random access procedure message that includes a random access preamble reception error indication; and performing, by the user device based on the received random access procedure message, one or more adjustments to improve time and/or frequency synchronization between the user device and the network node for transmission of a second random access preamble.

According to an example embodiment, a method may include receiving, by a network node from a user device, a first random access preamble; determining, by the network node, that at least one of a time synchronization offset and/or a frequency synchronization offset of the received first random access preamble is greater than a threshold, or that an improvement is required for at least one of a time adjustment and/or a frequency adjustment for uplink communication between the user device and the network node; and transmitting, by the network node to the user device based on the determining, a random access procedure message comprising: a random access preamble reception error indication that indicates that the first random access preamble is rejected based on at least one of a time synchronization offset and/or a frequency synchronization offset for the first random access preamble.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2A is a diagram illustrating operations of a 4-step random access (RACH) procedure according to an example embodiment.

FIG. 2B is a diagram illustrating operations of a 2-step random access (RACH) procedure according to an example embodiment.

FIG. 3 is a diagram illustrating a wireless non-terrestrial network according to an example embodiment.

FIG. 4 is a diagram illustrating an example situation where a UE has a perceived location that is different from the actual location of the UE.

FIG. 5 is a flow chart illustrating operation of a user device or UE according to an example embodiment.

FIG. 6 is a flow chart illustrating operation of a network node (e.g., such as a gNB) according to an example embodiment.

FIG. 7 is a diagram illustrating example signaling or control information that may be used to indicate or provide a random access preamble reception error indication and/or assistance information according to an example embodiment.

FIG. 8 is a diagram illustrating operation of UE according to an example embodiment.

FIG. 9 is a block diagram of a wireless station or node (e.g., network node, user node or UE, relay node, or other node).

### DETAILED DESCRIPTION

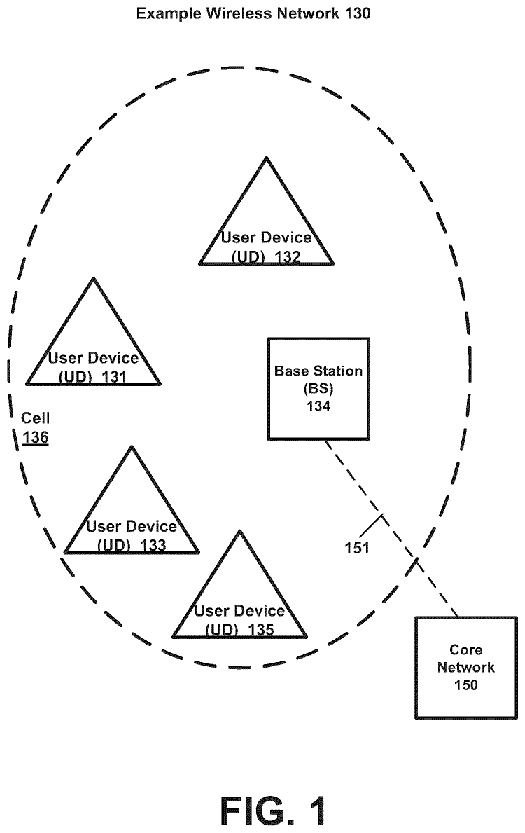

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

At least in some example cases, a UE may be in one of multiple states (e.g., such as one of three Radio Resource Control (RRC) states) with respect to a network node or gNB. In an Idle state (RRC Idle), there is typically no (or limited) RRC context (where a RRC context may include information or parameters necessary for communication between the UE and gNB/network node) stored in the RAN (radio access network) node (e.g., gNB) or network node, or UE, and the UE does not belong (or is not connected to) to a specific cell. From a core network perspective, the Idle UE is in an Idle (CM_Idle) state. No data transfer may typically occur between a UE and network node (e.g., gNB) when the UE is in an Idle state, as the UE sleeps (in a low power state) most of the time to conserve power. In an Idle state, a UE may typically periodically wake up to receive paging messages from the network.

A UE may transition from Idle state (e.g., RRC Idle) to a Connected state (e.g., RRC Connected state, where the UE is connected to the network node) by performing a random access (RACH) procedure with the gNB or network node. As part of the RACH procedure, both the UE and network node (e.g., gNB) may obtain the context, e.g., communication parameters necessary to allow UE-gNB communication. As an example communication parameter, the UE may obtain, e.g., as part of a RACH procedure with gNB or network node, a timing advance to allow the UE to perform uplink transmission to the gNB. The UE may also obtain a UE identity from the network, e.g., such as a cell-radio network temporary identifier (C-RNTI), which may be used by the UE for communication or signaling with the network or gNB. In a connected state (e.g., RRC Connected) with respect to a cell (or gNB or DU), the UE is connected to a gNB or network node, and the UE may receive data, and may send data (e.g., based on receiving an uplink grant).

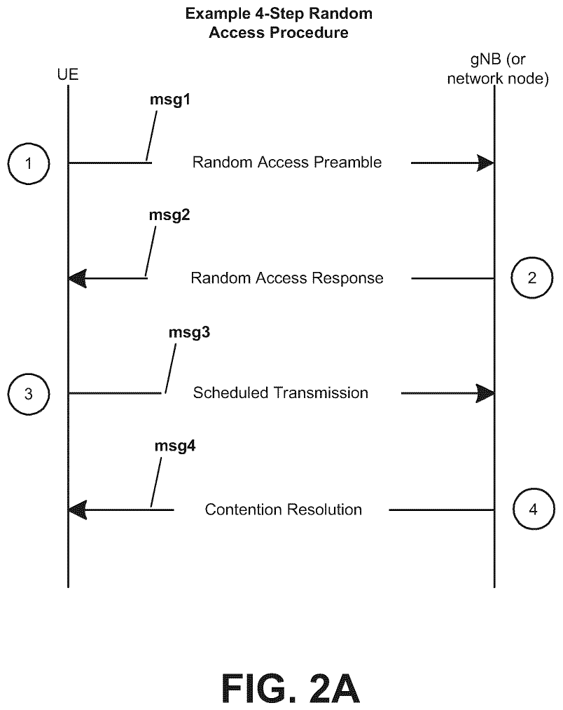

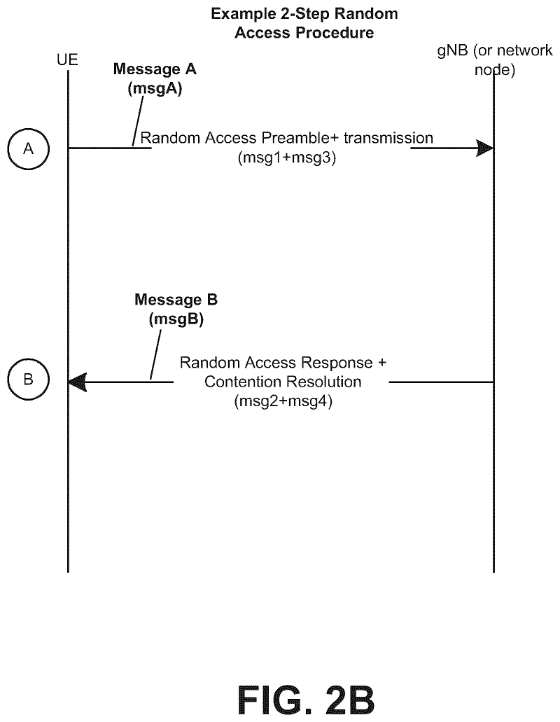

FIG. 2A is a diagram illustrating operations of a 4-step random access (RACH) procedure according to an example embodiment. When the RACH procedure is triggered (caused to be performed by the UE), the UE sends a random access (RACH) preamble over the random access (RACH) channel (Step 1), or msg1 (message 1). There are different groups of preambles defined or configured, depending on the size of msg3 (message 3) and based on the UE's channel conditions. The UE obtains information on how to access the RACH channel from system information block 1 (SIB1) broadcasted in the system information (SI) from the gNB. After receiving message 1 (random access preamble from the UE), the gNB determines the receive timing of the received random access preamble. Based on the receive timing of the received preamble (if there are no collisions with other UEs), the gNB determines a timing advance (or TA or timing advance command) to adjust the timing of the UE uplink frame to align with a downlink frame (and also to align uplink receive timing with other UE uplink frames). Because each UE may be provided at a different location, each UE may have a different radio propagation delay, and thus a different or specific timing advance with respect to a gNB. At Step 2 (msg2 or message 2), the gNB responds to the UE with a random access response (RAR), which may include an index to (or identifier of) the received random access (or RACH) preamble, the timing advance (TA, or timing advance command), a cell-radio network temporary identifier (C-RNTI) assigned to the UE, and an uplink grant to be used by the UE for uplink transmission of message 3 (msg3). Upon receiving the RAR message, the UE can send the first uplink transmission to the network (msg3 or message 3). The size of the transmission of msg3 depends on the grant received at step 2 (msg2 or message 2). Step 4 (msg 4 or message 4) involves the contention resolution phase.

Furthermore, as an alternative RACH procedure, a 2-step RACH (random access) procedure may be used to provide a faster random access procedure. FIG. 2B is a diagram illustrating operations of a 2-step random access (RACH) procedure according to an example embodiment. At message A (msgA), a UE may transmit a message that includes contents of both msg1 and msg3 as a first message (msgA) of the 2-step RACH procedure. And, for example, the network node or gNB may transmit msg2 and msg4 as a second message (or msgB or message B) of the 2-step RACH procedure.

However, in some situations and/or for some types of networks, synchronization errors may occur that cannot be adequately corrected based on the timing advance (TA) (e.g., TA command) that is typically provided within a random access response (RAR) message of a RACH procedure. For example, a time synchronization error may be present, e.g., due to a large radio propagation delay between UE and a network node, that cannot be adequately corrected by the limited direction and/or limited size of a TA command (e.g., a time synchronization error may occur that is larger than what the timing advance (TA) can correct, or may be in a direction (positive or negative timing correction) that the TA cannot correct). Also, in some cases or for some networks, a frequency synchronization offset may also be present, which is not addressed at all by the TA command of a RAR message, and thus cannot be corrected by the existing RAR message. Some examples and example networks are described below in which synchronization errors may arise, but it should be understood that the various embodiments and/or principles described herein may be applied to any wireless network.

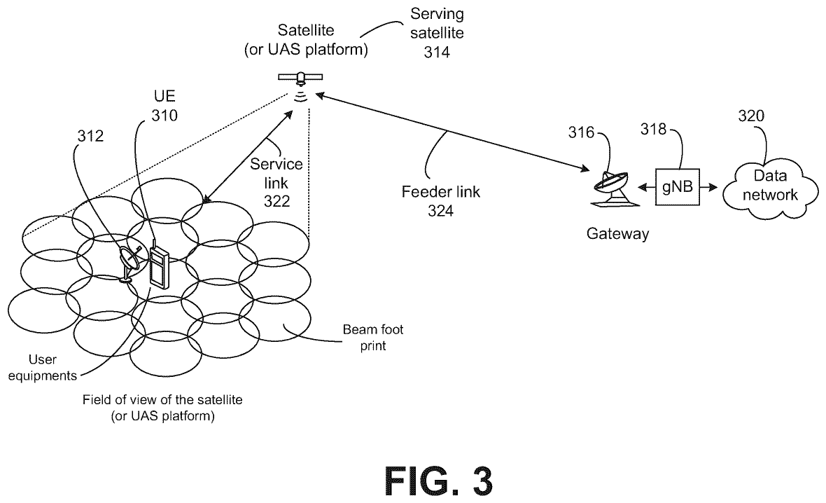

FIG. 3 is a diagram illustrating a wireless non-terrestrial network according to an example embodiment. The example non-terrestrial network shown in FIG. 3 may include a UE 310 that is in communication with a gNB (or network node) 318 via a serving satellite 314. The UE may be able to directly transmit (e.g., via higher power transmitter and/or satellite dish antenna as part of the UE) to the serving satellite 314. Alternatively, the UE may be connected (or may be co-located with) a separate satellite antenna dish (e.g., which may be provided on a vehicle, a boat, a plane, within a building, etc.), to allow the UE 310 to transmit to the gNB 318 via the serving satellite 314. Other configurations for the UE and/or a satellite antenna for the UE may be provided as well, to allow the UE to communicate via serving satellite 314 with gNB 318. Also, for example, gNB 318 may communicate with satellite 314 via a NTN gateway (GW) 316 (e.g., a satellite/gNB gateway, which may provide a conversion or interface between satellite communications (with satellite 314) and 5G/New Radio wireless communications (with gNB 318)). UE 310 may also include (within UE and/or as part of an external satellite antenna and transceiver connected to or in communication with UE 310) a similar GW or conversion block to allow the UE 310 to communicate via serving satellite 314. The gNB 318 may also be connected to a data network 320, such as the Internet or other data network. The wireless link between the UE 310 and serving satellite 314 may be referred to as the service link 322, while the wireless link between the gateway (GW) 316 and the serving satellite 314 may be referred to as the feeder link 324.

For example, gNB 318 may be located on the ground, and serving satellite 314 may perform frequency conversion and signal amplification. The GW 316 may be co-located with the gNB 318, or not. For example, the GW 316 may be at a location with a wireless link to the satellite 314, whereas the gNB 318 (e.g., including the baseband unit) may be at a location where is easy to maintain and operate the gNB, with a communications link provided between GW 316 and gNB 318.

In the example non-terrestrial network shown in FIG. 3, the signal (or radio wave) propagation time between the gNB 318 and UE 310 covers both feeder link 324 and service link 322. The downlink (DL) signal received by the UE 310 will undergo a one-way propagation delay. If the uplink (UL) frame timing is to be aligned with the DL frame timing at the gNB 318, the UE 310 needs to apply a timing advance (TA) or a time (or timing) adjustment that is equal to the round-trip delay when transmitting UL data. Also, for example, this time adjustment should be accurate enough that the arrival time of an OFDM (orthogonal frequency division multiplexing) symbol is received within the gNB receiver's cyclic prefix window in order to keep signals from multiple UEs from interfering each other.

Moreover, due to a significant satellite speed of, e.g., approximately 7.5 km/s for LEO (low earth orbit) deployments, the signal transmission on both service link 322 and feeder link 324 will be subject to a large frequency shift due to Doppler effect (or Doppler shift), mainly in form of a Doppler shift due to strong line of sight (LOS) character of both links. In an example embodiment, the feeder link Doppler shift (frequency shift of the received signal due to Doppler effect) in both downlink and uplink direction may be handled by the satellite subsystem (satellite 314 and NTN GW 316) in a way which is transparent to the gNB and UE.

However, for example, the UE 310 may still need to deal with (or compensate for) the Doppler shift on at least the service link 322, which may already span multiple subcarrier spacings (SCS), also depending on the elevation angle, for example. In the DL, this may require the UE to detect and compensate for a large frequency offset (or frequency error) caused by the Doppler shift, so that it can compensate for the frequency offset and detect the signal on the frequency grid and without significant inter-carrier interference (ICI). In the UL, the UE may need to pre-compensate for the Doppler shift on the service link so that the signal from all users/UEs reach the other end (e.g., gNB) of the link without large (relatively large) frequency offsets (or frequency errors) and (inter-user) ICI (inter-carrier interference) is avoided.

Therefore, UE 310 may adjust its carrier frequency in a way to pre-compensate for the service link Doppler shift. In order to determine a frequency adjustment to be applied as pre- compensation (to compensate for the Doppler shift on at least the service link 322), the UE 310 may use the so-called ephemeris information (location and speed vector of the serving satellite), which may be broadcasted regularly by the gNB 318 as part of the SIB (system information block), as well as the UE's own location. The serving satellite 314 may move on a predefined orbit, so location and speed of satellite is sufficient information for the UE to know the satellite's current and future positions, and/or path of the satellite.

The UE 310 may also have access to GNSS (Global Navigation Satellite Systems), such as GPS (Global Positioning System) signals. In this way, the UE 310 may be able to determine its own location. Based on its own location, and the location and speed of the serving satellite 314, the UE may be able to determine UL time/frequency alignment, including determining a time synchronization error (time synchronization offset) and/or a frequency synchronization error (frequency synchronization offset) (e.g., which may be due to the Doppler effect of the moving satellite, or other movement, such as movement of the UE). For example, the UE 310 can determine, based on its GNSS implementation, or based on received GPS signals one or more of: its position and/or a reference time and frequency. And, based on one or more of these elements together with additional information (e.g., serving satellite ephemeris or timestamp) signalled by the network node (gNB), the UE 310 can compute a time (or timing) adjustment and a frequency adjustment, and then apply (as pre-compensation, for example), for an uplink transmission, the timing (or time) adjustment and/or the frequency adjustment, in order to improve time synchronization and/or frequency synchronization between the UE 310 and gNB 318 via serving satellite 314.

One of the important elements of the GNSS (e.g., GPS) assistance information is that the GNSS (or GPS) information may not be accurate. There may be several sources for having inaccurate information from the GNSS system. The potential sources include at least following, as illustrative examples: a UE location with limited GNSS coverage, e.g., indoor or semi-indoor; dense urban environments, where UE has no or limited GNSS/GPS signals; deep forest (limited vision to wide sky), which may limit or impede UE receiving GNSS/GPS; GNSS/GPS location information may not be available or may not be accurate for UE; GNSS availability and accuracy; On top of the GNSS limitations, the overall time and frequency synchronization level of the UE may be impacted by one or more of the following: time/frequency reference provided via cellular network (e.g., if UE is using DL measurement); UE's hardware impairments (e.g., Local Oscillator) or a hardware failure; and/or a significant elapsed time since a previous GNSS/GPS reading/signals were received by UE, such that the previous calculated UE location is no longer accurate.

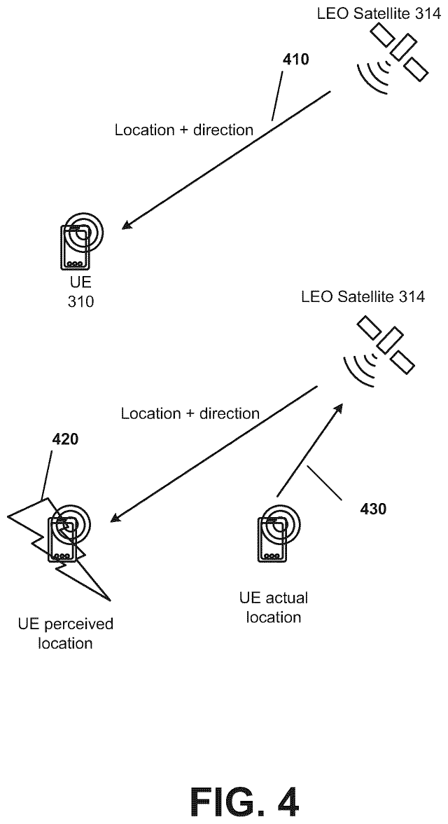

FIG. 4 is a diagram illustrating an example situation where a UE has a perceived location that is different from the actual location of the UE. In some cases, the UE may receive ephemeris information (location and speed of serving satellite) from the serving satellite 314. The UE may accurately determine a time adjustment and/or a frequency adjustment, based on the actual location of the UE and the location and speed information of the satellite, for example. On the other hand, at 420, the UE may be blocked from receiving GNSS/GPS signals, the UE may determine an inaccurate position of itself, e.g., the actual UE location may be different than the UE's perceived location of itself, e.g., due to missing or inaccurate GNSS/GPS information, for example. In this example, at 430, the UE may transmit a random access preamble or other UL transmission via serving satellite 314 that includes pre-compensation, which may attempt to compensate for a time synchronization error (time synchronization offset) by applying a time adjustment or time shift for UL transmission) and/or a frequency synchronization error (or frequency synchronization offset) by applying a frequency adjustment. For example, the frequency adjustment may be based on a calculated Doppler shift, for example. However, the time and/or frequency pre-compensation (e.g., time adjustment and/or frequency adjustment) will be inaccurate or erroneous if the UE's location is inaccurate (e.g., which may be due to missing or inaccurate or incomplete GNSS/GPS signals at the UE, for example, or other error). Thus, if the UE's perceived location is not aligned with (is not the same as) its actual location (see FIG. 4), or the UE is not able to derive (determine) GNSS-provided information with sufficient accuracy, the UE's internal algorithm using the UE's own understanding of its location to pre-compensate for a time synchronization error or offset and/or a frequency synchronization error or offset in uplink (UL) will be biased by an error.

As an illustrative example, for NTN (non-terrestrial network) systems, a UE may use (e.g., for the service link) UL time and frequency pre-compensation values based on a UE location that is determined based on GNSS/GPS signals. With uncertainty of the UE location, there is a risk that the UE has chosen misaligned values for pre-compensation in the random- access procedure. As a consequence, the random-access preamble may be received by the gNB with a large time offset or error (e.g., outside the RACH occasion (RO) window) and/or with a large frequency offset or error (e.g., which may be shifted by a multiple of subcarrier spacing (SCS)). Thus, the received random access preamble may be misaligned in time, and provided on an incorrect frequency, which may cause several problems, including: The RACH procedure may be unsuccessful; a random access response (RAR)/message 2 may not be sent, e.g., if time synchronization offset (or time synchronization error) and/or frequency synchronization offset (or frequency synchronization error) is greater than a threshold; the time synchronization offset may be greater than what can be corrected via the timing advance command (TA command) that is usually provided via RAR message/message 2 of a RACH procedure; Due to failed RACH procedure, service interruption may occur and/or handover to another network node or gNB may be delayed; preamble is misaligned and may thus interfere with signals (e.g., random access preambles) transmitted by other UEs, or cause ISI (intersymbol interference) and/or intercarrier interference with adjacent bands. Thus, such errors (e.g., erroneous time and frequency pre-compensation) may cause a service delay for the UE, but may also interfere with other UEs. Currently, there is no mechanism to allow the network or gNB to notify the UE that the UE has been blocked (UE location is inaccurate due to blocked GNSS signals), nor currently is there any mechanism to assist the UE to correct a time synchronization offset that is greater than what can be compensated by the timing advance command of RAR, or to assist the UE in correcting a frequency synchronization offset due to Doppler shift, for example. Thus, the UE may continue to re-transmit random access preambles with erroneous pre-compensation.

Therefore, various example embodiments are described to improve the performance of a random access (RACH) procedure, and/or may improve time synchronization and/or frequency synchronization for UEs with low synchronization quality. For example, a UE may transmit a first random access (RACH) preamble to a network node (e.g., gNB). The gNB may evaluate the timing and/or frequency of the received random access preamble and determine that at least one of a time synchronization offset and/or a frequency synchronization offset of the received first random access preamble is greater than a threshold, or that an improvement is required for at least one of a time synchronization and/or a frequency synchronization for uplink communication between the UE and the gNB. The gNB may transmit (and the UE may receive) a RACH procedure message, e.g., such as a random access response or message 2, which may include a random access preamble reception error indication that indicates that the first random access preamble is rejected based on at least one of a time synchronization offset and/or a frequency synchronization offset for the first random access preamble.

The RACH (random access) procedure message (which may be referred to as a random access message) may also include assistance information to assist or instruct the UE in improve time synchronization and/or frequency synchronization between the UE and the network node (e.g., which may be via a serving satellite in the case of a NTN network). The UE, based on the assistance information, may perform one or more adjustments to improve time and/or frequency synchronization between the UE and the network node (gNB) for transmission of a second random access preamble. The UE may transmit a second random access preamble to the network node based on the one or more adjustments. The UE may perform various adjustments to improve synchronization, such as, e.g., applying an additional frequency correction or frequency adjustment, based on a frequency adjustment instruction from the gNB, to improve frequency synchronization; apply a time adjustment based on an additional time adjustment value, e.g., which may be in addition to the timing advance command included as part of a standard random access response, to improve a time synchronization; perform another scan or search to obtain updated GNSS/GPS satellite signals so that the UE may determine a more accurate or updated UE location (which may result in the UE determining a more accurate time and/or frequency pre-compensation); use a dedicated or indicated RACH resource (indicated by the gNB) for transmission of a second random access preamble; transmit a second random access preamble via an indicated RACH procedure type, e.g., either a 2-step or 4-step RACH procedure as indicated by the gNB; adjust transmission power for transmission of a second random access preamble, as indicated or instructed by the gNB. These are some illustrative examples of adjustments that may be performed by the UE to improve UE-gNB synchronization, e.g., based on information or instructions that may be received by the UE from the gNB (such as via a message 2 or random access response or other message).

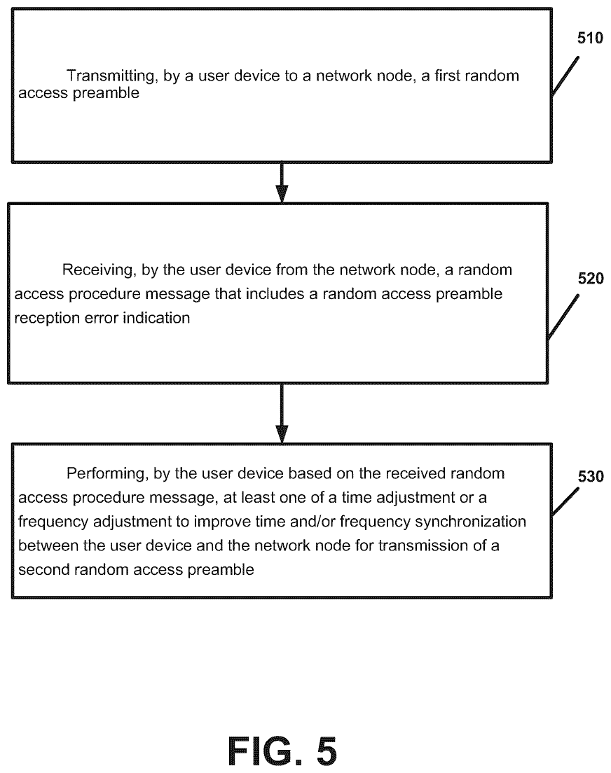

FIG. 5 is a flow chart illustrating operation of a user device or UE according to an example embodiment. Operation 510 includes transmitting, by a user device (UE) (e.g., UE 310, FIG. 3) to a network node (e.g., gNB), a first random access preamble. Operation 520 includes receiving, by the UE from the network node, a random access procedure message (e.g., a random access response or message 2, of a random access procedure) that includes a random access preamble reception error indication. And, operation 530 includes performing, by the UE based on the received random access response message, at least one of a time adjustment or a frequency adjustment to improve time and/or frequency synchronization between the user device and the network node for transmission of a second random access preamble. An example network for which this method or technique may be applied may be a wireless network, such as, for example, a non-terrestrial network (NTN), although the methods or embodiments may be applied to any type of network, including a terrestrial network. Thus, for example, the transmitting may include transmitting, by a UE to a network node (e.g., gNB 318, FIG. 3), a first random access preamble with pre-compensation that includes at least one of a frequency adjustment and a time adjustment. And, the performing one or more adjustments may include the UE performing, based on the received random access procedure message, one or more adjustments to improve time and/or frequency synchronization between the user device and the network node via the serving satellite for transmission of a second random access preamble.

The method of FIG. 5 may further include: receiving, by the UE, information indicating a location and a speed of the serving satellite; estimating, by the UE, a location of the UE; and, determining, by the UE, at least one of the frequency adjustment and the time adjustment based on the estimated UE location and the location and speed of the serving satellite, in attempt to provide time and frequency synchronization for uplink communication between the user device and the network node via the serving satellite. For example, the pre-compensation that includes at least one of the frequency adjustment and the time adjustment attempts to compensate for at least a portion of one or more of the following: a frequency synchronization offset due to a doppler effect based on movement of the serving satellite relative to the user device; and/or a time synchronization offset due to a radio wave propagation delay between the user device and the network node via the serving satellite.

The method of FIG. 5 may also include transmitting, by the user device (or UE) to the network node (e.g., gNB) based on the at least one of the time adjustment or the frequency adjustment, a second random access preamble as part of a second random access attempt by the user device.

Also, for example, for the method of FIG. 5, the random access procedure message may include: a random access preamble reception error indication that indicates that the first random access preamble has been received by the network node and has been rejected because at least one of a time adjustment or a frequency adjustment is required by the user device to achieve at least one of a time synchronization and/or a frequency synchronization for uplink communication between the user device and the network node; and assistance information to assist or instruct the user device in the performing at least one of the time adjustment or the frequency adjustment to improve time synchronization and/or frequency synchronization between the user device and the network node. For example, the random access procedure message may include a random access preamble reception error indication that is indicated based on at least one of the following: a bit or a flag in the random access procedure message set to a value that indicates a random access preamble reception error indication; or an indicator provided at a location in the random access procedure message that indicates a random access preamble reception error indication.

Also, for example, with respect to the method of FIG. 5, the random access preamble reception error indication may include: an indicator provided within a sub protocol data unit, wherein the sub protocol data unit is located at a position within the random access procedure message that is not assigned to indicate a backoff indication, thereby the indicator indicating a random access preamble reception error indication.

Also, for example, with respect to the method of FIG. 5, the indicator may be provided at a position or within a sub protocol data unit assigned for backoff indication of the random access procedure message provides a backoff indication; and/or the indicator provided at a position or within a sub protocol data unit that is not the position or is not the protocol data unit assigned for backoff indication provides a random access preamble reception error indication.

Also, for example, with respect to the method of FIG. 5, the random access procedure message may further include assistance information that assists or instructs the user device in the performing at least one of the time adjustment or the frequency adjustment to improve time synchronization and/or frequency synchronization between the user device and the network node for transmission of a second random access preamble.

Also, for example, with respect to the method of FIG. 5, the random access procedure message may include: a Type field that is either: 1) set to a value and/or is 2) provided at a position or within a sub protocol data unit of the random access procedure message to provide a random access preamble reception error indication; a random access preamble identifier corresponding to or identifying the first random access preamble; and, assistance information that assists or instructs the user device in the performing at least one of the time adjustment or the frequency adjustment to improve time synchronization and/or frequency synchronization between the user device and the network node for transmission of a second random access preamble. For example, the Type field may include: a Type field set to a value and provided at a position or within a sub protocol data unit that is not a position or is not a sub protocol data unit assigned for backoff indication or is provided at a position assigned for random access preamble reception error indication, in order to provide a random access preamble reception error indication.

Also, for example, with respect to the method of FIG. 5, the receiving, by the user device of the random access preamble reception error indication means that at least one of the following is true:

Also, for example, with respect to the method of FIG. 5, the receiving, by the user device of the random access preamble reception error indication means that at least one of the following is true: at least one of an uplink time synchronization offset or an uplink frequency synchronization offset for uplink communication between the user device and the network node is greater than a threshold; the uplink time synchronization offset for uplink communication between the user device and the network node is greater than what can be adjusted by the network node via a Timing Advance field that can be received by the user device from the network node in a random access response within a message 2 or message B of a random access procedure; or the uplink time synchronization offset for uplink communication between the user device and the network node is in a direction that cannot be adjusted by the network node via a Timing Advance field that can be received by the user device from the network node in a random access response within a message 2 or message B of a random access procedure.

Also, for example, with respect to the method of FIG. 5, the receiving, by the user device of the random access preamble reception error indication means that at least one of the following is true: the random access procedure message comprises assistance information that assists or instructs the user device in the performing at least one of the time adjustment or the frequency adjustment to improve time synchronization and/or frequency synchronization between the user device and the network node for transmission of a second random access preamble, wherein the assistance information comprises at least one of: a frequency correction indication or an additional frequency offset to be applied by the user device for an uplink transmission to improve a frequency synchronization offset; a time adjustment indication or time adjustment value, beyond or in addition to a Timing Advance, to be applied by the user device for an uplink transmission to improve a time synchronization offset; a command to the user device to perform another search or re-scan for more accurate satellite positioning signals received from positioning satellites in order for the user device to more accurately estimate its position; an indication of an additional time shift to be applied by the user device for a next or a second random access preamble transmission to reduce a likelihood of a collision with a transmission from another user device; information identifying a random access resource for the user device to transmit a second random access preamble via a contention free random access procedure; information identifying a random access procedure type, either 2-step or 4-step random access procedure type, to be used for a next or second transmission of a random access preamble; or a power command that instructs the user device to adjust its transmission power for a transmission of a next or second random access preamble.

Also, for example, with respect to the method of FIG. 5, the transmitting may include transmitting, by a user device to a network node via a serving satellite that is part of a non-terrestrial wireless network, a first random access preamble; and wherein the performing comprises performing, by the user device based on the received random access response message, at least one of a time adjustment or a frequency adjustment to improve time and/or frequency synchronization between the user device and the network node via the serving satellite for transmission of a second random access preamble.

Also, for example, with respect to the method of FIG. 5, the method may further include receiving, by the user device, information indicating a location and a speed of the serving satellite; estimating, by the user device, a location of the user device; determining, by the user device, pre-compensation that includes at least one of the frequency adjustment and the time adjustment based on the estimated user device location and the location and speed of the serving satellite, in attempt to provide or improve time and frequency synchronization for uplink communication between the user device and the network node via the serving satellite. Also, for example, the pre-compensation that includes at least one of the frequency adjustment and the time adjustment attempts to compensate for at least a portion of one or more of the following: a frequency synchronization offset due to a doppler effect based on movement of the serving satellite relative to the user device; and/or a time offset due to a radio wave propagation delay between the user device and the network node via the serving satellite.

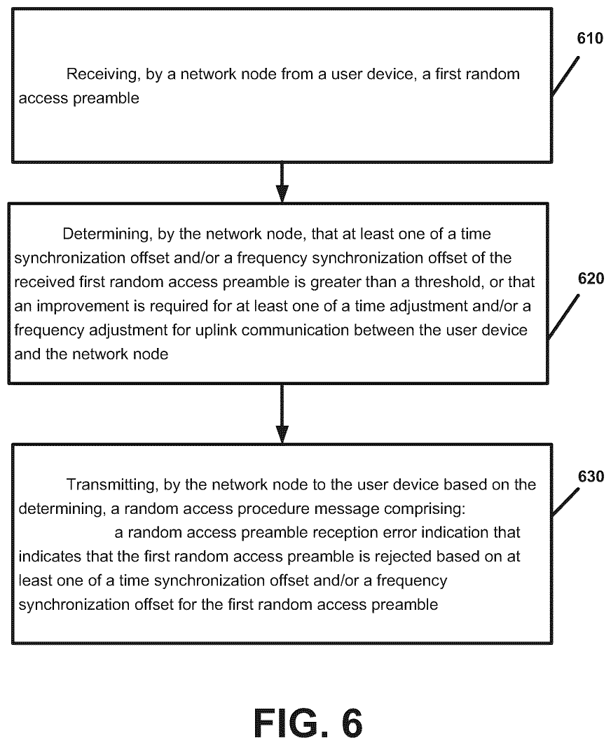

FIG. 6 is a flow chart illustrating operation of a network node (e.g., such as a gNB) according to an example embodiment. Operation 610 includes receiving, by a network node (e.g., gNB) from a user device (or UE), a first random access preamble. Operation 620 includes determining, by the network node, that at least one of a time synchronization offset and/or a frequency synchronization offset of the received first random access preamble is greater than a threshold, or that an improvement is required for at least one of a time adjustment and/or a frequency adjustment for uplink communication between the user device and the network node. And, operation 630 includes determining, by the network node (e.g., gNB), that at least one of a time synchronization offset and/or a frequency synchronization offset of the received first random access preamble is greater than a threshold, or that an improvement is required for at least one of a time adjustment and/or a frequency adjustment for uplink communication between the user device and the network node. And, operation 630 includes transmitting, by the network node to the user device based on the determining, a random access procedure message comprising: a random access preamble reception error indication that indicates that the first random access preamble is rejected based on at least one of a time synchronization offset and/or a frequency synchronization offset for the first random access preamble.

As noted, a UE may transmit a first random access (RACH) preamble to a network node (e.g., gNB). The gNB may evaluate the timing and/or frequency of the received random access preamble, and may determine whether a time synchronization offset (or time synchronization error) and/or a frequency synchronization offset (or frequency synchronization error) of the received first random access preamble is greater than a threshold, or whether an improvement is required for at least one of a time synchronization and/or a frequency synchronization for uplink communication between the UE and the gNB. For example, if the time synchronization offset and frequency synchronization offset are less than specific thresholds, then the random access preamble is accepted by the gNB transmitting a random access response (message 2) with a C-RNTI, a timing advance command, and an uplink grant, as per existing 5G/NR standards define as behavior for a RACH procedure.

However, if the gNB determines that a time synchronization offset and/or a frequency synchronization offset of the received first random access preamble is greater than a threshold(s), or that an improvement is required for at least one of a time synchronization and/or a frequency synchronization for uplink communication between the UE and the gNB (or that an improvement is required for at least one of a time adjustment and/or a frequency adjustment for uplink communication between the user device and the network node), the gNB rejects the first random access preamble by transmitting a random access procedure message (e.g., such as a random access response or message 2) that may include: a random access preamble reception error indication that indicates that the first random access preamble is rejected based on at least one of a time synchronization offset and/or a frequency synchronization offset for the first random access preamble (e.g., which may mean or may indicate that at least one of the time synchronization offset and/or the frequency synchronization offset is greater than a threshold, and thus, UL communication cannot be performed, and the RACH preamble is rejected), and assistance information to assist or instruct the UE in improving time synchronization and/or frequency synchronization between the UE and the network node. The UE, based on the random access preamble reception error indication and/or assistance information, may perform one or more adjustments to improve time and/or frequency synchronization between the UE and the network node (gNB) for transmission of a second random access preamble. For example, the UE may, by the user device based on the received random access procedure message, at least one of a time adjustment or a frequency adjustment to improve time and/or frequency synchronization between the user device and the network node for transmission of a second random access preamble. The UE may transmit a second random access preamble to the network node based on the one or more adjustments (e.g., based on the at least one of the time (or transmission timing) adjustment and/or frequency adjustment performed by the UE).

Based on the random access preamble reception error indication and/or the assistance information, the UE may perform various adjustments to improve synchronization, such as, e.g., applying an additional frequency correction or frequency adjustment, based on a frequency adjustment instruction (as an example assistance information, or which may be included within the assistance information) from the gNB, to improve frequency synchronization; apply a time adjustment based on an additional time adjustment value, e.g., which may be in addition to the timing advance or timing (or time) adjustment command included as part of a standard random access response, to improve a time synchronization; perform another scan or search to obtain updated GNSS/GPS satellite signals (e.g., based on a request or instruction from gNB to re-scan or search for updated GNSS/GPS satellite positioning signals) so that the UE may determine a more accurate or updated UE location (which may result in the UE determining a more accurate time and/or frequency pre-compensation); use a dedicated or indicated RACH resource (indicated by the gNB) for transmission of a second random access preamble; transmit a second random access preamble via an indicated RACH procedure type, e.g., either a 2-step or 4-step RACH procedure as indicated by the gNB; adjust transmission power for transmission of a second random access preamble, as indicated or instructed by the gNB. These are some illustrative examples of adjustments that may be performed by the UE to improve UE-gNB synchronization, e.g., based on information or instructions that may be received by the UE from the gNB (such as via a message 2 or random access response, such as within the assistance information of the random access response, or other message).

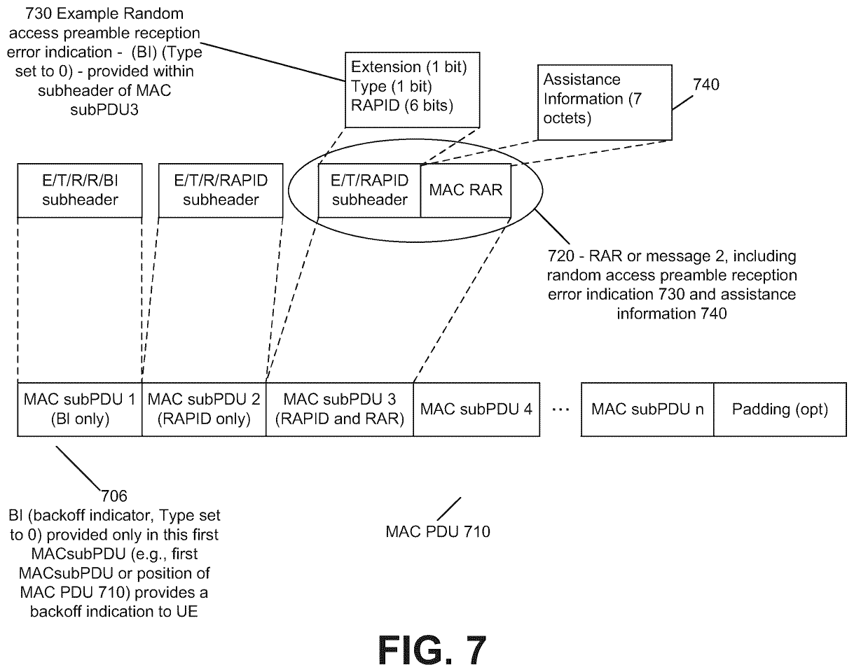

In general, a RACH (random access) message may include a bit or flag (or other information) set to a value, or provided in a position, or provided within a specific MAC sub PDU, to indicate or provide a random access preamble reception error indication. The assistance information may also be provided within the RACH procedure message. FIG. 7 provides an illustrative example of one example way in which a random access preamble reception error indication and/or assistance information may be provided within a RACH procedure message or other message.

FIG. 7 is a diagram illustrating example signaling or control information that may be used to indicate or provide a random access preamble reception error indication and/or assistance information according to an example embodiment. As shown in FIG. 7, a MAC (media access control) PDU (protocol data unit) 710 is shown that includes several sub-PDUs, including MAC subPDU1, MAC subPDU2, MAC subPDU3, MAC subPDU4, . . . MACsubPDUn, and padding that that be added at the end of the MAC PDU.

In current 3GPP specifications, the MAC PDU that carries the Random Access Response (RAR) may include 3 types of MAC sub PDUs.
1) Back-Off Indicator (BI): which typically is used to instruct the UE to backoff or delay before re-transmitting a random access preamble again. The BI is always provided in the first MAC subPDU (e.g., MACsubPDU1 in FIG. 7) in the sequence of MACsubPDUs. It is an optional part of the MAC PDU and can be submitted only when needed (usually in congested situations);
2) A RAPID only type of response (which is provided within MACsubPDU2 in example of FIG. 7), with no payload, where RAPID refers to Random Access Preamble Identifier, which identifies the index of the received random access preamble. Usually used for SI (system information) request acknowledgment—only in specific preambles. And,
3) A RAPID followed by a Random Access Response (RAR) message or RAR payload (which is provided within MACsubPDU3 in example of FIG. 7).

The chain or sequence of MAC subPDUs may include several MAC subPDUs (there are 64 RAPIDs available for UEs). The UEs can identify all the parts of the MAC PDU based on a few rules, such as:

In every MAC subPDU header, the first two bits are for:
1) E(xtension): If 0, this is the last subPDU on the chain.
2) T(ype): If 0, this is the BI (backoff indicator) type of subPDU. If 1, this is the “RAPID” type of response. By knowing whether the RAPID belongs to a subset reserved for SI request or not, the UE will know if there is a payload or not following the subPDU header.

As currently provided by current 3GPP specifications, the BI indicator, as indicated includes 2 reserved bits and 4 BI bits. There is no RAPID (no index to the received random access preamble) in the BI, so there is no specific addressing (only general addressing to all UEs or all random access preambles). All UEs that cannot read a response for its RAPID within the response window time, should apply the Back-off as indicated in the 4 BI bits. As noted, the current 3GPP specifications require that the BI is limited to the very first position (very first MACsubPDU, shown as MACsubPDU1 in MAC PDU 710 in FIG. 7), in the MAC PDU chain.

Thus, this first MACsubPDU (MACsubPDU1) within MAC PDU 710 includes: E/T/R/R/BI, where E is the Extension bit, T is the Type bit (e.g., set to 0 to indicate BI type of subPDU), R refers to two reserved bits, and BI refers to 4 BI bits. Also, the MAC subPDU that includes the RAR (MACsubPDU3 in FIG. 7) includes: E/T/RAPID followed by MAC RAR, where E is the Extension bit, T is the Type bit, and MAC RAR refers to the random access response or message 2 of the RACH procedure (e.g., which may traditionally include C-RNTI and UL grant, if the random access preamble was received and accepted by the gNB). At 706 of FIG. 7, the BI (e.g., Type bit set to 0) may only be provided within the first MACsubPDU (e.g., MACsubPDU1 within MAC PDU 710, FIG. 7), in order to provide a backoff indication to the UE.

According to an example embodiment, the BI (e.g., Type bit set to 0 to indicate backoff indicator) may be provided at a different position or within a different MACsubPDU (other than the first position or first MACsubPDU) to provide or indicate the random access preamble reception error indication. As noted, the BI (e.g., Type bit set to 0) may only be provided within the first MACsubPDU (e.g., MACsubPDU1 within MAC PDU 710, FIG. 7), in order to provide a backoff indication to the UE.

According to an example embodiment, the BI (Backoff Indicator, e.g., Type bit set to 0) may be provided at a position or within a different MACsubPDU (not the first MACsubPDU), in order to provide the random access preamble reception error indication. For example, the random access preamble reception error indication may be provided as either: 1) a backoff indicator (BI) (e.g., Type set to 0) provided at a location in the random access procedure message that indicates a random access preamble reception error indication (e.g., provided at a location, or within a MACsubPDU(s) that are assigned or permitted to provide the BI indicator to indicate a random access preamble reception error indication; or 2) a backoff indicator (BI) provided within a sub protocol data unit, wherein the sub protocol data unit is located at a position within the random access procedure message that is not assigned to indicate a backoff indication, thereby the backoff indicator indicating a random access preamble reception error indication (e.g., a BI provided within any of the MACsubPDUs other than the first MACsubPDU (e.g., MACsubPDU1 in FIG. 7) that is assigned to the backoff indication). Thus, in such a case, the BI (e.g., Type bit set to 0) could be renamed the “BI/random access preamble reception error flag”, which if set to 0 (according to this illustrative example) indicates either: 1) a backoff indication (if present within the first MACsubPDU) or 2) a random access (RACH) preamble reception error (if present at another position or within a different MACsubPDU, or provided at a specific position or MACsubPDU assigned for this purpose of signaling the random access preamble reception error).

Thus, for example, the presence of the BI (e.g., Type bit set to 0), or the “BI/random access preamble reception error flag”, may have two different meanings, depending on its position or within which MACsubPDU it is provided: 1) a backoff indicator (BI) (or Type set to 0) provided at a position or within a sub protocol data unit assigned for backoff indication (e.g., MACsubPDU1 in FIG. 7) of the random access procedure message provides a backoff indication; and 2) a backoff indicator (BI) (or Type set to 0) provided at a position or within a sub protocol data unit that is not the position or is not the protocol data unit assigned for backoff indication (e.g., provided within MACsubPDU3, or other MACsubPDU that is not MACsubPDU1) provides (or is interpreted as) a random access preamble reception error indication.

Therefore, according to an example embodiment, if the BI or “BI/random access preamble reception error flag”, is provided in a position (e.g., within a MACsubPDU) that is different from the first position (e.g., different than the first MACsubPDU) of the MAC PDU, the UE interprets this as a random access preamble reception error indication due to the UE's inaccurate UL time synchronization and/or frequency synchronization.

The BI is defined by a bit on the “Type” flag (within the E/T/RAPID subheader of the MAC RAR) that is toggled to indicate a MAC subPDU from the BI type. In the legacy format, the BI may have 8 bits defined as:
Extension (1 bit)
Type (1 bit)
Reserved (2 bits)
Back-off indication (4 bits).

According to an example embodiment, if the BI (or the “BI/random access preamble reception error flag”) is not present in the very first position (first MACsubPDU of RAR, which is MACsubPDU1 in FIG. 7), but is present within a different MACsubPDU and includes the BI bitflag (e.g., Type set to 0), then this provides an indication of a random access preamble reception error, and may have the following format, interpreted as follows (see 730 in FIG. 7):
Extension (1 bit)
Type (1 bit)=BI.

RAPID (6 bits) (identifying the random access preamble that was received for which the random access preamble reception error indication is being provided.

This means that, for the random access preamble reception error indication, the resources corresponding to the two “reserved” bits and the four bits of “back-off indication” in the BI, are now used as RAPID bits in the BI. Therefore, based on the RAPID (identifying the index of the received random access preamble, corresponding to the random access preamble transmitted by the UE), the UE will know it has received a UE-specific BI (that identifies the random access preamble the UE transmitted), as it has received a RAPID attached to it, wherein the BI and the RAPID may be interpreted by the UE as a random access preamble reception error indication for the UE.

The assistance information may be provided or included within the RAR payload 740, as part of the message 2. The follow up contents of the assistance information (730) may be on the same size as the old RAR information (to preserve the capacity of other legacy UEs to interpret the RAR chain). For example, there are 7 octets for conveying the backoff information to the UE. In this case, there is no need to provide an UL Grant or a T-CRNTI for this user (since the random access preamble is being rejected), since the Random Access is not successful. Therefore, the 7 octets may be used to provide the assistance information 740 and/or a random access preamble reception error indication, such as a contention free preamble for the UE to initiate the random access after frequency pre compensation is adjusted, or other assistance information as listed above, for example.

Thus, for example, a RACH procedure message may include a Type field that is either: 1) set to a value and/or is 2) provided at a position or within a sub protocol data unit of the random access procedure message to provide a random access preamble reception error indication; a random access preamble identifier (e.g., such as the RAPID, provided within header 730) corresponding to or identifying the first random access preamble; assistance information (e.g., such as assistance information provided within RAR payload 740) that assists or instructs the user device to perform one or more adjustments to improve time synchronization and/or frequency synchronization between the user device and the network node for transmission of a second random access preamble.

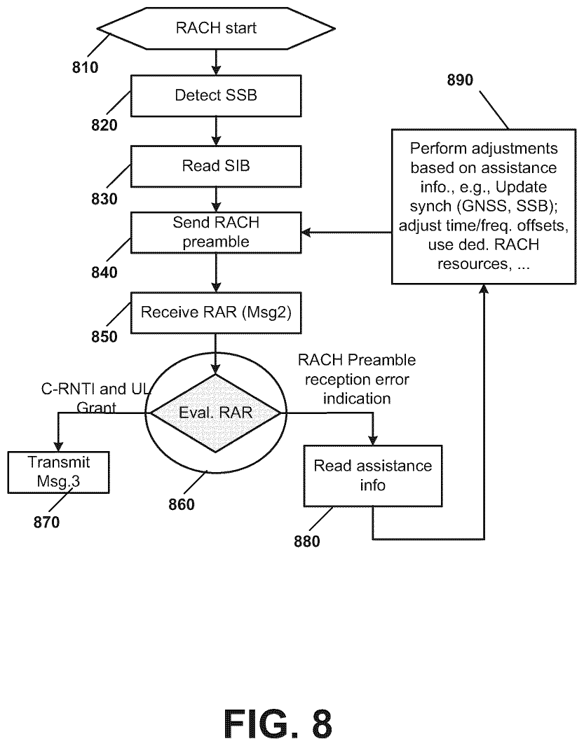

FIG. 8 is a diagram illustrating operation of UE according to an example embodiment. At 810, the UE begins the RACH procedure. At 820, the UE detects or receives synchronization signal blocks (SSBs) from the gNB, to obtain synchronization information. At 830, system information block (SIB) is received by the UE from the gNB, e.g., to obtain ephemeris information for a serving satellite, such as the location and speed of the serving satellite. Also, the UE may receive satellite positioning signals from GNSS/GPS, and estimates its own location/position. The UE may, for example, perform time/frequency pre-compensation for a first random access preamble, e.g., to provide time synchronization and/or frequency synchronization between the UE and gNB via the serving satellite, e.g., taking into account time shift and/or Doppler shift. At 840, the UE may transmit the first random access preamble, which may include its pre-compensation. As noted, errors in its location, or other errors, may result in time synchronization offset and/or frequency synchronization offset, as determined by the gNB that receives the random access preamble. At 850, the UE may receive a random access response (RAR) or message 2, based on its transmitted random access preamble (e.g., which may be a MAC PDU 710, and/or RAR 720). At 860, the UE may evaluate the contents of the RAR, and determine whether the random access preamble was accepted (e.g., by presence of C-RNTI and UL grant, and/or absence of a random access preamble reception error indication), or rejected (e.g., by presence of a random access preamble reception error indication) by the gNB. In the event the random access preamble is accepted (e.g., because the time synchronization offset or error and/or frequency synchronization offset or error are less than a threshold(s)), the UE receives the RAR (random access response, or message 2) that includes a C-RNTI, a timing advance (TA) command (the standard TA provided in message 2), and an UL grant, and at 870, the UE may then transmit a RACH procedure message 3 using the granted resources. On the other hand, if the random access preamble is rejected by the gNB (e.g., based on detection of a random access preamble reception error indication in the RAR at 860), the UE may then read the assistance information. At 890, the UE, e.g., based on the random access preamble reception error indication and/or the assistance information, may perform one or more adjustments to improve time and/or frequency synchronization between the UE and the network node (gNB) for transmission of a second random access preamble. At 840, the UE may transmit a second random access preamble to the network node based on the one or more adjustments.

The UE may perform various adjustments to improve synchronization, such as, e.g., applying an additional frequency correction or frequency adjustment, based on a frequency adjustment instruction (e.g., which may be included as part of assistance information) from the gNB, to improve frequency synchronization; apply a time adjustment based on an additional time adjustment value, e.g., which may be in addition to the timing advance command included as part of a standard random access response, to improve a time synchronization; perform another scan or search to obtain updated GNSS/GPS satellite signals so that the UE may determine a more accurate or updated UE location (which may result in the UE determining a more accurate time and/or frequency pre-compensation); use a dedicated or indicated RACH resource (indicated by the gNB) for transmission of a second random access preamble; transmit a second random access preamble via an indicated RACH procedure type, e.g., either a 2-step or 4-step RACH procedure as indicated by the gNB; adjust transmission power for transmission of a second random access preamble, as indicated or instructed by the gNB. These are some illustrative examples of adjustments that may be performed by the UE to improve UE-gNB synchronization, e.g., based on information or instructions that may be received by the UE from the gNB (such as via a message 2 or random access response or other message).

Some further examples will be provided.

Example 1. A method comprising: transmitting, by a user device to a network node, a first random access preamble; receiving, by the user device from the network node, a random access procedure message that includes a random access preamble reception error indication; and performing, by the user device based on the received random access procedure message, at least one of a time adjustment or a frequency adjustment to improve time and/or frequency synchronization between the user device and the network node for transmission of a second random access preamble.

Example 2. The method of example 1, further comprising: transmitting, by the user device to the network node based on the at least one of the time adjustment or the frequency adjustment, a second random access preamble as part of a second random access attempt by the user device.

Example 3. The method of any of examples 1-2, wherein the random access procedure message comprises: a random access preamble reception error indication that indicates that the first random access preamble has been received by the network node and has been rejected because at least one of a time adjustment or a frequency adjustment is required by the user device to achieve at least one of a time synchronization and/or a frequency synchronization for uplink communication between the user device and the network node; and assistance information to assist or instruct the user device in the performing at least one of the time adjustment or the frequency adjustment to improve time synchronization and/or frequency synchronization between the user device and the network node.

Example 4. The method of any of examples 1-3, wherein the random access procedure message comprises a random access preamble reception error indication that is indicated based on at least one of the following: a bit or a flag in the random access procedure message set to a value that indicates a random access preamble reception error indication; or an indicator provided at a location in the random access procedure message that indicates a random access preamble reception error indication.

Example 5. The method of any of examples 1-4, wherein the random access preamble reception error indication comprises: an indicator provided within a sub protocol data unit, wherein the sub protocol data unit is located at a position within the random access procedure message that is not assigned to indicate a backoff indication, thereby the indicator indicating a random access preamble reception error indication.

Example 6. The method of any of examples 1-5, wherein: the indicator provided at a position or within a sub protocol data unit assigned for backoff indication of the random access procedure message provides a backoff indication; and the indicator provided at a position or within a sub protocol data unit that is not the position or is not the protocol data unit assigned for backoff indication provides a random access preamble reception error indication.

Example 7. The method of any of examples 1-6, wherein the random access procedure message further comprises assistance information that assists or instructs the user device in the performing at least one of the time adjustment or the frequency adjustment to improve time synchronization and/or frequency synchronization between the user device and the network node for transmission of a second random access preamble.

Example 8. The method of any of examples 1-7, wherein the random access procedure message comprises: a Type field that is either: 1) set to a value and/or is 2) provided at a position or within a sub protocol data unit of the random access procedure message to provide a random access preamble reception error indication; a random access preamble identifier corresponding to or identifying the first random access preamble; assistance information that assists or instructs the user device in the performing at least one of the time adjustment or the frequency adjustment to improve time synchronization and/or frequency synchronization between the user device and the network node for transmission of a second random access preamble.

Example 9. The method of example 8, wherein the Type field comprises: a Type field set to a value and provided at a position or within a sub protocol data unit that is not a position or is not a sub protocol data unit assigned for backoff indication or is provided at a position assigned for random access preamble reception error indication, in order to provide a random access preamble reception error indication.

Example 10. The method of any of examples 1-9, wherein the receiving, by the user device of the random access preamble reception error indication means that at least one of the following is true: at least one of an uplink time synchronization offset or an uplink frequency synchronization offset for uplink communication between the user device and the network node is greater than a threshold; the uplink time synchronization offset for uplink communication between the user device and the network node is greater than what can be adjusted by the network node via a Timing Advance field that can be received by the user device from the network node in a random access response within a message 2 or message B of a random access procedure; or the uplink time synchronization offset for uplink communication between the user device and the network node is in a direction that cannot be adjusted by the network node via a Timing Advance field that can be received by the user device from the network node in a random access response within a message 2 or message B of a random access procedure.

Example 11. The method of any of examples 1-10, wherein the random access procedure message comprises assistance information that assists or instructs the user device in the performing at least one of the time adjustment or the frequency adjustment to improve time synchronization and/or frequency synchronization between the user device and the network node for transmission of a second random access preamble, wherein the assistance information comprises at least one of: a frequency correction indication or an additional frequency offset to be applied by the user device for an uplink transmission to improve a frequency synchronization offset; a time adjustment indication or time adjustment value, beyond or in addition to a Timing Advance, to be applied by the user device for an uplink transmission to improve a time synchronization offset; a command to the user device to perform another search or re-scan for more accurate satellite positioning signals received from positioning satellites in order for the user device to more accurately estimate its position; an indication of an additional time shift to be applied by the user device for a next or a second random access preamble transmission to reduce a likelihood of a collision with a transmission from another user device; information identifying a random access resource for the user device to transmit a second random access preamble via a contention free random access procedure; information identifying a random access procedure type, either 2-step or 4-step random access procedure type, to be used for a next or second transmission of a random access preamble; or a power command that instructs the user device to adjust its transmission power for a transmission of a next or second random access preamble.

Example 12. The method of any of examples 1-11: wherein the transmitting comprises transmitting, by a user device to a network node via a serving satellite that is part of a non-terrestrial wireless network, a first random access preamble; and wherein the performing comprises performing, by the user device based on the received random access response message, at least one of a time adjustment or a frequency adjustment to improve time and/or frequency synchronization between the user device and the network node via the serving satellite for transmission of a second random access preamble.

Example 13. The method of example 12, further comprising: receiving, by the user device, information indicating a location and a speed of the serving satellite; estimating, by the user device, a location of the user device; determining, by the user device, pre-compensation that includes at least one of the frequency adjustment and the time adjustment based on the estimated user device location and the location and speed of the serving satellite, in attempt to provide or improve time and frequency synchronization for uplink communication between the user device and the network node via the serving satellite.

Example 14. The method of any of examples 12-13, wherein the pre-compensation that includes at least one of the frequency adjustment and the time adjustment attempts to compensate for at least a portion of one or more of the following: a frequency synchronization offset due to a doppler effect based on movement of the serving satellite relative to the user device; and/or a time offset due to a radio wave propagation delay between the user device and the network node via the serving satellite.

Example 15. An apparatus comprising means for performing the method of any of examples 1-14.

Example 16. A non-transitory computer-readable storage medium comprising instructions stored thereon that, when executed by at least one processor, are configured to cause a computing system to perform the method of any of examples 1-14.

Example 17. An apparatus comprising: at least one processor; and at least one memory including computer program code; the at least one memory and the computer program code configured to, with the at least one processor, cause the apparatus at least to perform the method of any of examples 1-14.

Example 18. A method comprising: receiving, by a network node from a user device, a first random access preamble; determining, by the network node, that at least one of a time synchronization offset and/or a frequency synchronization offset of the received first random access preamble is greater than a threshold, or that an improvement is required for at least one of a time adjustment and/or a frequency adjustment for uplink communication between the user device and the network node; and transmitting, by the network node to the user device based on the determining, a random access procedure message comprising: a random access preamble reception error indication that indicates that the first random access preamble is rejected based on at least one of a time synchronization offset and/or a frequency synchronization offset for the first random access preamble.

Example 19. The method of example 18, further comprising: receiving, by the network node from the user device, a second random access preamble as part of a second random access attempt by the user device.

Example 20. The method of any of examples 18-19, wherein the random access procedure message comprises: a random access preamble reception error indication that indicates that the first random access preamble has been received by the network node and has been rejected because at least one of a time adjustment or a frequency adjustment is required by the user device to achieve at least one of a time synchronization and/or a frequency synchronization for uplink communication between the user device and the network node; and assistance information to assist or instruct the user device in the performing at least one of the time adjustment or the frequency adjustment to improve time synchronization and/or frequency synchronization between the user device and the network node.

Example 21. The method of any of examples 18-20, wherein the random access procedure message comprises a random access preamble reception error indication that is indicated based on at least one of the following: a bit or a flag in the random access procedure message set to a value that indicates a random access preamble reception error indication; or an indicator provided at a location in the random access procedure message that indicates a random access preamble reception error indication.

Example 22. The method of any of examples 18-21, wherein the random access preamble reception error indication comprises: an indicator provided within a sub protocol data unit, wherein the sub protocol data unit is located at a position within the random access procedure message that is not assigned to indicate a backoff indication, thereby the indicator indicating a random access preamble reception error indication.

Example 23. The method of any of examples 18-22, wherein: the indicator provided at a position or within a sub protocol data unit assigned for backoff indication of the random access procedure message provides a backoff indication; and the indicator provided at a position or within a sub protocol data unit that is not the position or is not the protocol data unit assigned for backoff indication provides a random access preamble reception error indication.

Example 24. The method of any of examples 18-23, wherein the random access procedure message comprises assistance information that assists or instructs the user device in the performing at least one of a time adjustment or a frequency adjustment to improve time synchronization and/or frequency synchronization between the user device and the network node for transmission of a second random access preamble.

Example 25. The method of any of examples 18-24, wherein the random access procedure message comprises: a Type field that is either: 1) set to a value and/or is 2) provided at a position or within a sub protocol data unit of the random access procedure message to provide a random access preamble reception error indication; a random access preamble identifier corresponding to or identifying the first random access preamble; assistance information that assists or instructs the user device in the performing at least one of the time adjustment or the frequency adjustment to improve time synchronization and/or frequency synchronization between the user device and the network node for transmission of a second random access preamble.

Example 26. The method of example 25, wherein the Type field comprises: a Type field set to a value and provided at a position or within a sub protocol data unit that is not a position or is not a sub protocol data unit assigned for backoff indication or is provided at a position assigned for random access preamble reception error indication, in order to provide a random access preamble reception error indication.

Example 27. The method of any of examples 18-26, wherein the transmitting, by the network node to the user device of the random access procedure message that includes the random access preamble reception error indication means that at least one of the following is true: at least one of an uplink time synchronization offset or an uplink frequency synchronization offset for uplink communication between the user device and the network node is greater than a threshold; the uplink time synchronization offset for uplink communication between the user device and the network node is greater than what can be adjusted by the network node via a Timing Advance field that can be received by the user device from the network node in a random access response within a message 2 or message B of a random access procedure; or the uplink time synchronization offset for uplink communication between the user device and the network node is in a direction that cannot be adjusted by the network node via a Timing Advance field that can be received by the user device from the network node in a random access response within a message 2 or message B of a random access procedure.

Example 28. The method of any of examples 18-27, wherein the random access procedure message comprises assistance information that assists or instructs the user device in performing at least one of a time adjustment or a frequency adjustment to improve time synchronization and/or frequency synchronization between the user device and the network node for transmission of a second random access preamble, wherein the assistance information comprises at least one of: a frequency correction indication or an additional frequency offset to be applied by the user device for an uplink transmission to improve a frequency synchronization offset; a time adjustment indication or time adjustment value, beyond or in addition to a Timing Advance, to be applied by the user device for an uplink transmission to improve a time synchronization offset; a command to the user device to perform another search or re-scan for more accurate satellite positioning signals received from positioning satellites in order for the user device to more accurately estimate its position; an indication of an additional time shift to be applied by the user device for a next or a second random access preamble transmission to reduce a likelihood of a collision with a transmission from another user device; information identifying a random access resource for the user device to transmit a second random access preamble via a contention free random access procedure; information identifying a random access procedure type, either 2-step or 4-step random access procedure type, to be used for a next or second transmission of a random access preamble; or, a power command that instructs the user device to adjust its transmission power for a transmission of a next or second random access preamble.

Example 29. The method of any of examples 18-28: wherein the receiving comprises receiving, by the network node from the user device via a serving satellite that is part of a non-terrestrial wireless network, a first random access preamble.

Example 30. The method of example 29: wherein the receiving comprises receiving, by a network node from a user device via a serving satellite that is part of a non-terrestrial wireless network, a first random access preamble; wherein the determining comprises determining, by the network node, that at least one of a time synchronization offset and/or a frequency synchronization offset of the received first random access preamble is greater than a threshold, or that an improvement is required for at least one of a time adjustment and/or a frequency adjustment for uplink communication between the user device and the network node via the serving satellite; and wherein the transmitting comprises transmitting, by the network node to the user device via the serving satellite based on the determining, the random access procedure message.

Example 31. An apparatus comprising means for performing the method of any of examples 18-30.

Example 32. A non-transitory computer-readable storage medium comprising instructions stored thereon that, when executed by at least one processor, are configured to cause a computing system to perform the method of any of examples 18-30.

Example 33. An apparatus comprising: at least one processor; and at least one memory including computer program code; the at least one memory and the computer program code configured to, with the at least one processor, cause the apparatus at least to perform the method of any of examples 18-30.

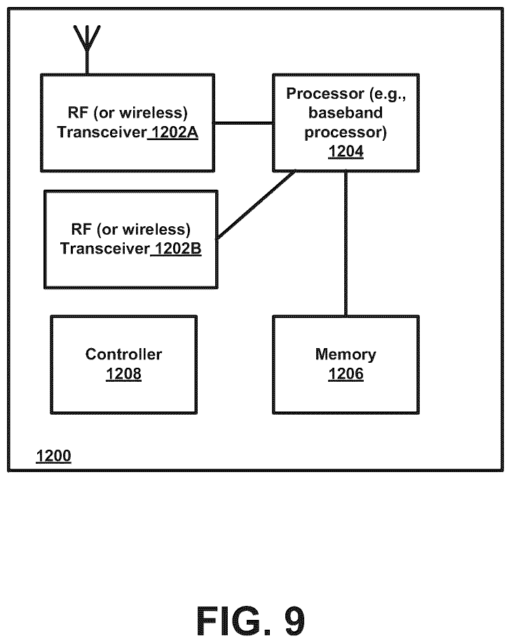

FIG. 9 is a block diagram of a wireless station or node (e.g., UE, user device, AP, BS, eNB, gNB, RAN node, network node, TRP, or other node) 1200 according to an example embodiment. The wireless station 1200 may include, for example, one or more (e.g., two as shown in FIG. 9) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 9, a controller (or processor) 1208 may execute software and instructions, and may provide overall control for the station 1200, and may provide control for other systems not shown in FIG. 9, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-33. (canceled)

34. A method comprising:
transmitting, by a user device to a network node, a first random access preamble;
receiving, by the user device from the network node, a random access procedure message that includes a random access preamble reception error indication; and
performing, by the user device based on the received random access procedure message, at least one of a time adjustment or a frequency adjustment to improve time and/or frequency synchronization between the user device and the network node for transmission of a second random access preamble.

35. The method of claim 34, further comprising:
transmitting, by the user device to the network node based on the at least one of the time adjustment or the frequency adjustment, a second random access preamble as part of a second random access attempt by the user device.

36. The method of claim 34, wherein the random access procedure message comprises:
a random access preamble reception error indication that indicates that the first random access preamble has been received by the network node and has been rejected because at least one of a time adjustment or a frequency adjustment is required by the user device to achieve at least one of a time synchronization and/or a frequency synchronization for uplink communication between the user device and the network node; and
assistance information to assist or instruct the user device in the performing at least one of the time adjustment or the frequency adjustment to improve time synchronization and/or frequency synchronization between the user device and the network node.

37. The method of claim 34, wherein the random access procedure message comprises a random access preamble reception error indication that is indicated based on at least one of the following:
a bit or a flag in the random access procedure message set to a value that indicates a random access preamble reception error indication; or
an indicator provided at a location in the random access procedure message that indicates a random access preamble reception error indication.

38. The method of claim 34, wherein the random access preamble reception error indication comprises:
an indicator provided within a sub protocol data unit, wherein the sub protocol data unit is located at a position within the random access procedure message that is not assigned to indicate a backoff indication, thereby the indicator indicating a random access preamble reception error indication.

39. The method of claim 34, wherein:
the indicator provided at a position or within a sub protocol data unit assigned for backoff indication of the random access procedure message provides a backoff indication; and
the indicator provided at a position or within a sub protocol data unit that is not the position or is not the protocol data unit assigned for backoff indication provides a random access preamble reception error indication.

40. The method of claim 34, wherein the random access procedure message further comprises assistance information that assists or instructs the user device in the performing at least one of the time adjustment or the frequency adjustment to improve time synchronization and/or frequency synchronization between the user device and the network node for transmission of a second random access preamble.

41. The method of claim 34, wherein the random access procedure message comprises:
a Type field that is either: 1) set to a value and/or is 2) provided at a position or within a sub protocol data unit of the random access procedure message to provide a random access preamble reception error indication;
a random access preamble identifier corresponding to or identifying the first random access preamble;
assistance information that assists or instructs the user device in the performing at least one of the time adjustment or the frequency adjustment to improve time synchronization and/or frequency synchronization between the user device and the network node for transmission of a second random access preamble.

42. The method of claim 41, wherein the Type field comprises:
a Type field set to a value and provided at a position or within a sub protocol data unit that is not a position or is not a sub protocol data unit assigned for backoff indication or is provided at a position assigned for random access preamble reception error indication, in order to provide a random access preamble reception error indication.

43. The method of claim 34, wherein the receiving, by the user device of the random access preamble reception error indication means that at least one of the following is true:
at least one of an uplink time synchronization offset or an uplink frequency synchronization offset for uplink communication between the user device and the network node is greater than a threshold;
the uplink time synchronization offset for uplink communication between the user device and the network node is greater than what can be adjusted by the network node via a Timing Advance field that can be received by the user device from the network node in a random access response within a message 2 or message B of a random access procedure; or
the uplink time synchronization offset for uplink communication between the user device and the network node is in a direction that cannot be adjusted by the network node via a Timing Advance field that can be received by the user device from the network node in a random access response within a message 2 or message B of a random access procedure.

44. The method of claim 34, wherein the random access procedure message comprises assistance information that assists or instructs the user device in the performing at least one of the time adjustment or the frequency adjustment to improve time synchronization and/or frequency synchronization between the user device and the network node for transmission of a second random access preamble, wherein the assistance information comprises at least one of:
a frequency correction indication or an additional frequency offset to be applied by the user device for an uplink transmission to improve a frequency synchronization offset;
a time adjustment indication or time adjustment value, beyond or in addition to a Timing Advance, to be applied by the user device for an uplink transmission to improve a time synchronization offset;
a command to the user device to perform another search or re-scan for more accurate satellite positioning signals received from positioning satellites in order for the user device to more accurately estimate its position;
an indication of an additional time shift to be applied by the user device for a next or a second random access preamble transmission to reduce a likelihood of a collision with a transmission from another user device;
information identifying a random access resource for the user device to transmit a second random access preamble via a contention free random access procedure;
information identifying a random access procedure type, either 2-step or 4-step random access procedure type, to be used for a next or second transmission of a random access preamble; or
a power command that instructs the user device to adjust its transmission power for a transmission of a next or second random access preamble.

45. The method of claim 34, wherein the transmitting comprises transmitting, by a user device to a network node via a serving satellite that is part of a non-terrestrial wireless network, a first random access preamble; and
wherein the performing comprises performing, by the user device based on the received random access response message, at least one of a time adjustment or a frequency adjustment to improve time and/or frequency synchronization between the user device and the network node via the serving satellite for transmission of a second random access preamble.

46. The method of claim 45, further comprising:
receiving, by the user device, information indicating a location and a speed of the serving satellite;
estimating, by the user device, a location of the user device;
determining, by the user device, pre-compensation that includes at least one of the frequency adjustment and the time adjustment based on the estimated user device location and the location and speed of the serving satellite, in attempt to provide or improve time and frequency synchronization for uplink communication between the user device and the network node via the serving satellite.

47. The method of claim 45, wherein the pre-compensation that includes at least one of the frequency adjustment and the time adjustment attempts to compensate for at least a portion of one or more of the following:
a frequency synchronization offset due to a doppler effect based on movement of the serving satellite relative to the user device; and/or
a time offset due to a radio wave propagation delay between the user device and the network node via the serving satellite.

48. An apparatus comprising:
at least one processor; and
at least one memory including computer program code;
the at least one memory and the computer program code being configured to, with the at least one processor, cause the apparatus at least to:
transmit, by a user device to a network node, a first random access preamble;
receive, by the user device from the network node, a random access procedure message that includes a random access preamble reception error indication; and
perform, by the user device based on the received random access procedure message, at least one of a time adjustment or a frequency adjustment to improve time and/or frequency synchronization between the user device and the network node for transmission of a second random access preamble.

49. An apparatus comprising:
at least one processor; and
at least one memory including computer program code;
the at least one memory and the computer program code configured to, with the at least one processor, cause the apparatus at least to:
receive, by a network node from a user device, a first random access preamble;
determine, by the network node, that at least one of a time synchronization offset and/or a frequency synchronization offset of the received first random access preamble is greater than a threshold, or that an improvement is required for at least one of a time adjustment and/or a frequency adjustment for uplink communication between the user device and the network node; and
transmit, by the network node to the user device based on the determining, a random access procedure message comprising:
a random access preamble reception error indication that indicates that the first random access preamble is rejected based on at least one of a time synchronization offset and/or a frequency synchronization offset for the first random access preamble.
